(19) United States
(12) Patent Application Publication
(10) Pub. No.: US 2015/0314715 A1
(43) Pub. Date: Nov. 5, 2015

(54) TRAVEL CUSHION

(71) Applicant: TEMPUR-PEDIC MANAGEMENT, LLC, Lexington, KY (US)

(72) Inventors: Tyler W. KILGORE, Kingsport, TN (US); Christopher ARENDOSKI, Cross Point Farms, MI (US)

(73) Assignee: Tempur-Pedic Management, LLC, Lexington, KY (US)

(21) Appl. No.: 14/649,967

(22) PCT Filed: Dec. 28, 2012
(86) PCT No.: PCT/US12/71957

§ 371 Date: Jun. 5, 2015

(51) Int. Cl. B60N 2/48; B60N 2/66

(52) U.S. Cl. CPC B60N 2/4879; B60N 2/66; B60N 2/665

(57) ABSTRACT

A cushion includes a foam body having first and second lateral support portions defining an elongated recess therebetween. The cushion can also include a cover at least partially enclosing the foam body and means for releasably coupling the cushion to a support member to facilitate transport of the support member and the cushion as a unit. Also, the cushion can include another body positioned in the recess, removable from the recess for use in supporting a lumbar or posterior area of a user, and releasably attachable within the recess by one or more fasteners.

### FIELD OF THE INVENTION

The present invention relates to cushions, and more particularly to cushions for use during travel.

### BACKGROUND OF THE INVENTION

Travel cushions are typically utilized to support a user's body or a portion thereof (e.g., the user's head) while seated in an airplane, car, and the like. Some travel cushions include a cover surrounding a support material such as foam, feathers, or batting. Such cushions typically require removal of the cover from the support material before the user can wash the cushion. Conventional travel cushions are also often heavy and bulky, and thus difficult to store while traveling and to transport when not needed by the user.

### SUMMARY OF THE INVENTION

The invention provides, in one aspect, a cushion including a foam body having first and second lateral support portions defining an elongated recess therebetween, The cushion also includes a cover at least partially enclosing the foam body and means for releasably coupling the cushion to a support member to facilitate transport of the support member and the cushion as a unit.

The invention provides, in another aspect, a cushion including a first foam body having first and second lateral support portions defining an elongated recess therebetween, and a first cover at least partially enclosing the first foam body. The cushion also includes a second foam body positioned in the recess and removably coupled to the first foam body. The cushion further includes a second cover at least partially enclosing the second foam body.

The invention provides, in yet another aspect, a cushion including a foam sleeve having an interior, and a bladder positioned in the sleeve interior. The bladder is selectively deflated to facilitate rolling the foam sleeve into a cylindrical shape.

Other features and aspects of the invention will become apparent by consideration of the following detailed description and accompanying drawings.

### BRIEF DESCRIPTION OF THE DRAWINGS

FIG. 1 is a perspective view of a cushion in accordance with an embodiment of the invention.

FIG. 2 is a cross-sectional view of the cushion of FIG. 1, taken along line 2-2 in FIG. 1.

FIG. 3 is a perspective view of a cushion in accordance with another embodiment of the invention.

FIG. 4 is a cross-sectional view of the cushion of FIG. 3, taken along line 4-4 in FIG. 3, with a portion of the cushion removed for clarity.

FIG. 5 is a perspective view of a cushion in accordance with yet another embodiment of the invention.

FIG. 6 is a cross-sectional view of the cushion of FIG. 5, taken along line 6-6 in FIG. 5.

FIG. 7 is another perspective view of the cushion of FIG. 5, illustrating the cushion in a deflated state and rolled up for storage.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

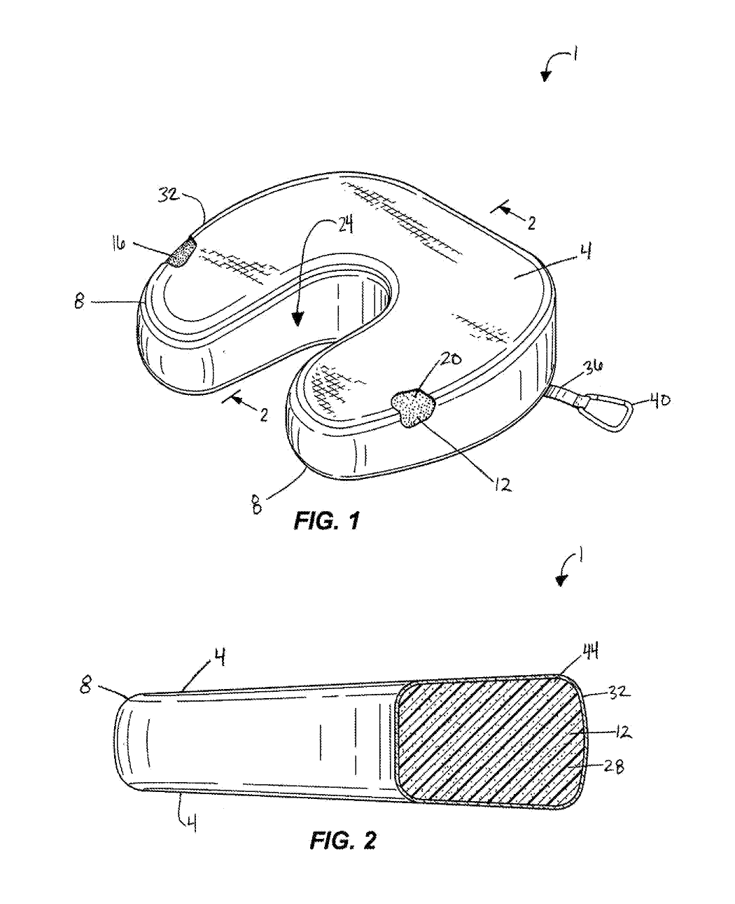

FIG. 1 illustrates a cushion 1 used during travel or transit by a user. The cushion 1 has generally flat or smooth surfaces 4 and rounded edges 8. Alternatively, the surfaces 4 of the cushion, and of any other embodiments of the travel cushion disclosed herein, may have any number of peaks, valleys, ribs, troughs, bumps, dimples, and/or other features. In still other alternative embodiments, the edges 8 of the cushion 1 may be more or less rounded. The cushion 1 includes a foam body 12 having first and second lateral support portions 16, 20 defining an elongated recess 24 therebetween. The elongated recess 24 of the illustrated cushion 1 is open to a side of the cushion 1 as illustrated, thereby enabling insertion and removal of the cushion in a position about the body part (e.g., neck) of a user laterally. In other words, by virtue of the fact that the elongated recess is open to a side of the cushion 1, the user's body part can be inserted in the cushion 1 from a side of the cushion 1 as opposed to a top or bottom of the cushion 1.

In the illustrated embodiment of the cushion 1, the foam body 12 has a tapered cross-sectional shape in a plane aligned with the recess 24 (FIG. 2). Alternatively, the cushion 1 may include a non-tapered cross-sectional shape in a plane aligned with the recess 24. With continued reference to FIG. 2, in the illustrated embodiment of the cushion 1, the foam body 12 includes a single viscoelastic foam layer 28. Alternatively, the cushion 1 may include a second foam layer in addition to the single viscoelastic foam layer 28. Such a second foam layer may include viscoelastic foam or non-viscoelastic foam (e.g., latex foam, high-resilience (FIR) polyurethane foam, etc.). In still other alternative embodiments, the foam body 12 may include any number of layers of viscoelastic foam and/or non-viscoelastic foam, which may be arranged in a variety of combinations (e g, alternating layers of viscoelastic foam and non-viscoelastic foam, a layer of viscoelastic foam supported by or adjacent two layers of non-viscoelastic foam, etc.).

Viscoelastic foam is sometimes referred to as “memory foam” or “low resilience foam.” Coupled with the slow recovery characteristic of the viscoelastic foam, the foam body 12 can at least partially conform to the user's body or body portion (e.g., head, neck; hereinafter referred to as “body”), thereby distributing the force applied by the user's body upon the foam body 12. The foam body 12 can provide a relatively soft and comfortable surface for the user's body.

In some embodiments, the viscoelastic foam body 12 has a hardness of at least about 20 N and no greater than about 80 N for desirable softness and body-conforming qualities. Alternatively, the viscoelastic foam body 12 may have a hardness of at least about 30 N and no greater than about 70 N. In still other alternative embodiments, the viscoelastic foam body 12 may have a hardness of at least about 40 N and no greater than about 60 N. Unless otherwise specified, the hardness of a material referred to herein is measured by exerting pressure from a plate against a sample of the material to a compression of 40 percent of an original thickness of the material at approximately room temperature (e.g., 21 to 23 degrees Celsius). The 40 percent compression is held for a set period of time, following the International Organization of Standardization (ISO) 2439 hardness measuring standard.

With continued reference to FIGS. 1 and 2, the viscoelastic foam body 12 can also have a density providing a relatively high degree of material durability. The density of the viscoelastic foam body 12 can impact other characteristics of the foam, such as the manner in which the foam body 12 responds to pressure, and the feel of the viscoelastic foam body 12. In the illustrated embodiment, the viscoelastic foam body 12 has a density of no less than about 30 kg/m³ and no greater than about 150 kg/m³. Alternatively, the viscoelastic foam body 12 may have a density of at least about 40 kg/m³ and no greater than about 135 kg/m³. In still other alternative embodiments, the viscoelastic foam body 12 may have a density of at least about 50 kg/m³ and no greater than about 120 kg/m³.

The viscoelastic foam body 12 can be made from non-reticulated or reticulated viscoelastic foam. Reticulated viscoelastic foam has characteristics that are well suited for use in the cushion 1, including the enhanced ability to permit fluid movement through the reticulated viscoelastic foam, thereby providing enhanced air and/or heat movement within, through, and away from the foam body 12. Reticulated foam is a cellular foam structure in which the cells of the foam are essentially skeletal. In other words, the cells of the reticulated foam are each defined by multiple apertured windows surrounded by struts. The cell windows of the reticulated foam can be entirely gone (leaving only the cell struts) or substantially gone. For example, the foam may be considered “reticulated” if at least 50 percent of the windows of the cells are missing (i.e., windows having apertures therethrough, or windows that are completely missing and therefore leaving only the cell struts). Such structures can be created by destruction or other removal of cell window material, or preventing the complete formation of cell windows during the manufacturing process.

In an alternative embodiment of the cushion 1, the foam body 12 may include a non-viscoelastic foam such as a latex foam or a HR polyurethane foam. Such a latex foam may have a hardness of at least about 30 N and no greater than about 130 N for a desirable overall cushion firmness and “bounce.” In still other alternative embodiments, the latex foam may have a hardness of at least about 40 N and no greater than about 120 N, or at least about 50 N and no greater than about 110 N. In some embodiments, the latex foam has a density of no less than about 40 kg/m³ and no greater than about 100 kg/m³. In still other alternative embodiments, the latex foam may have a density of at least about 50 kg/m³ and no greater than about 100 kg/m³, or at least about 60 kg/m³ and no greater than about 100 kg/m³.

In an alternative embodiment of the cushion 1 in which the foam body 12 includes HR polyurethane foam, such a foam may include an expanded polymer (e.g., expanded ethylene vinyl acetate, polypropylene, polystyrene, or polyethylene), and the like. In some embodiments, the HR polyurethane has a hardness of at least about 80 N and no greater than about 200 N for a desirable overall cushion firmness and “bounce,” In still other alternative constructions, the HR polyurethane foam may have a hardness of at least about 90 N and no greater than about 190 N, or at least about 100 N and no greater than about 180 N.

The HR polyurethane foam may have a density which provides a reasonable degree of material durability to the foam body 12. The HR polyurethane foam may also impact other characteristics of the foam body 12, such as the manner in which the foam body 12 responds to pressure. In some embodiments, the HR polyurethane foam has a density of no less than about 10 kg/m³ and no greater than about 80 kg/m³. In still other alternative constructions, the HR polyurethane foam may have a density of no less than about 15 kg/m³ and no greater than about 70 kg/m³, or no less than about 20 kg/m³ and no greater than about 60 kg/m³.

With reference to FIGS. 1 and 2, the cushion 1 also includes a cover 32 that at least partially encloses the foam body 12. In the illustrated embodiment of the cushion 1, the cover 32 completely encloses the foam body 12 such that the cover 32 and foam body 12 form a washable unit. In other words, the cushion 1 can be washed by the user without removal of the foam body 12 from the cover 32. The cover 32 may include any material or combinations of materials, such as nylon, polyester, and other synthetic materials, cotton, wool, and other natural fibers, and the like, any of which may be in a woven or non-woven form in the cover 32. The cover 32 may be vapor and/or liquid permeable or non-permeable. Additionally, the cover 32 may be coated, such as with a waterproof or vapor-proof layer of material.

With continued reference to FIGS. 1 and 2, the cushion 1 further includes means for releasably coupling the cushion 1 to a support member (e.g., luggage, not shown) to facilitate transport of the support member and the cushion 1 as a unit. Particularly, the illustrated coupling means includes a strap 36 extending from the cover 32 and a latch (e.g., a carabiner 40) attached to the strap 36 (FIG. 1). The carabiner 40 may be used to releasably fasten or attach the cushion 1 to a support member. Alternatively, the carabiner 40 may be omitted, and instead the strap 36 may be releasably fastened to itself (e.g., using hook and loop fastener material, snaps, buttons, buckles, etc.) such that the user may loop the strap 36 about a portion of the support member before fastening the strap 36 to itself to fasten or attach the cushion 1 to the support member, In still other alternative embodiments, the coupling means may include any other fastener suitable for releasably securing the cushion 1 to a support member, such as a pair of straps extending from the cover 32 that are releasably coupled to each other (e.g., by tying together, using hook and loop fastener material, buttons, snaps, buckles, etc.), to fasten or attach the cushion 1 to the support member.

When using the cushion 1, the lateral support portions 16, 20 of the foam body 12 are positioned around a neck of the user to provide lateral support to the neck of the user, whereas a rear 44 of the foam body 12 (FIG. 2) may directly support the rear of the user's neck. When the cushion 1 is not in use, the cushion 1 is attachable to a support member (e.g., luggage, not shown) with the carabiner 40 for easy and convenient transport of the cushion 1 with the support member as a unit. As needed, the cushion 1 is washable by the user without necessitating removal of the foam body 12 from the cover 32 as compared to a conventional cushion, which requires removal of the foam body before the cover is washed.

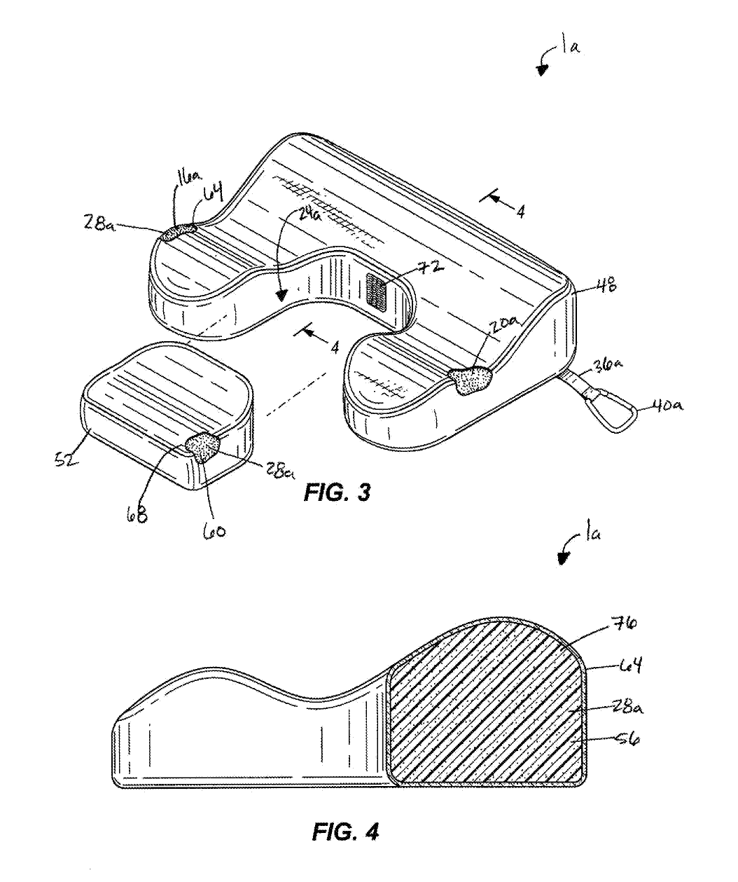

FIGS. 3 and 4 illustrate a second embodiment of a cushion 1a used during travel or transit by a user. Like components are identified with like reference numerals with the letter “a,” and will not be described again in detail. Rather than incorporating a single foam body 12 like that shown in FIGS. 1 and 2 and described above, the cushion 1a includes first and second cushion portions 48, 52 removably coupled to each other. The first and second cushion portions 48, 52 include first and second foam bodies 56, 60, respectively, and the second cushion portion 52 is positionable in a recess 24a defined by lateral support portions 16a, 20a of the first foam body 56 (FIG. 3). Like the cushion 1 described above in connection with FIGS. 1 and 2, the recess 24a in the illustrated embodiment is open to a side of the cushion 1a.

Each of the first and second foam bodies 56, 60 includes a single viscoelastic foam layer 28a. Alternatively, the first and/or second foam bodies 56, 60 may include a non-viscoelastic foam layer (e.g., latex foam, HR polyurethane foam, etc.). The properties (e.g., hardness, density, etc.) of the viscoelastic foam, latex foam, and HR polyurethane foam discussed above with respect to the first embodiment of the cushion 1 also apply to the cushion 1a of FIGS. 3 and 4, and will not be described again in detail. In still other alternative embodiments, the first and/or second cushion portions 48, 52 may include a second foam layer in addition to the single viscoelastic foam layer 28a. Such a second foam layer may be made from viscoelastic foam or non-viscoelastic foam (e.g., latex foam, HR polyurethane foam, etc.). In still further alternative embodiments, the first and second foam bodies 56, 60 may include any number of layers of viscoelastic foam and/or non-viscoelastic foam, which may be arranged in a variety of combinations (e.g, alternating layers of viscoelastic foam and non-viscoelastic foam, a layer of viscoelastic foam supported by two layers of non-viscoelastic foam, etc.).

The first and second foam bodies 56, 60 in the illustrated embodiment have a undulating or sinusoidal cross-sectional shape in a plane aligned with the recess 24a (FIG. 4). In other embodiments, only one of the first and second foam bodies 56, 60 has such a shape, or neither has such a shape. However, the undulating or sinusoidal shape of the first and second foam bodies 56, 60 provides desirable supportive properties for a user's head (which can be received within a valley of the undulating or sinusoidal shape) and for the user's neck (which can rest against a peak of the undulating or sinusoidal shape). This advantageous relationship between a user's body and an undulating or sinusoidal shape described above is particularly experienced when the first and second foam bodies 56, 60 are connected and used together as a pillow, although similar advantages can be obtained when only one of the first and second foam bodies 56, 60 has such a shape. The second foam body 60, and thus the second cushion portion 52, can be configured to support a lumbar region or a posterior region of the user when the second cushion portion 52 is uncoupled and removed from the first cushion portion 48. When coupled together, the first and second cushion portions 48, 52 are contoured or configured to support the neck and a head of the user in a reclined position (e.g., when lying in a bed).

With reference to FIGS. 3 and 4, the first and second cushion portions 48, 52 include first and second covers 64, 68, respectively, which at least partially enclose the respective first and second foam bodies 56, 60. In the illustrated embodiment, the first and second foam bodies 56, 60 are entirely or completely enclosed by the first and second covers 64, 68, respectively, to form two separate washable units. Additionally, the first and second foam bodies 56, 60 and the first and second covers 64, 68 are all washable as a unit when the first and second cushion portions 48, 52 are coupled to each other. The illustrated cushion 1a also includes means for securing the first and second covers 64, 68. Particularly, the securing means includes a hook and loop fastener material 72 (FIG. 3). The hook and loop fastener material 72 may be used to releasably fasten or attach the first and second cushion portions 48, 52 to each other. Alternatively, the securing means may include snaps, buttons, ties, etc., or any other suitable fastener In still other alternative embodiments, the first and second cushion portions 48, 52 may be secured to each other by an interference fit between the second cushion portion 52 and the recess 24a in the first cushion portion 48.

With continued reference to FIG. 3, the cushion 1a also includes means for releasably coupling the cushion 1a to a support member (e.g., luggage, not shown) to facilitate transport of the support member and the cushion 1a as a unit. Particularly, the coupling means includes a strap 36a extending from the first cover 64 and a latch (e.g., carabiner 40a) attached to the strap 36a. The carabiner 40a may be used to releasably fasten or attach the cushion 1a to the support member. Alternatively the carabiner 40a may be omitted, and instead the strap 36a may be releasably fastened to itself (e.g., using hook and loop fastener material, snaps, buttons, buckles, etc.) such that the user may loop the strap 36a about a portion of the support member before fastening the strap 36a to itself to fasten or attach the cushion 1a to the support member. In still other alternative embodiments, the coupling means may include any other fastener suitable for releasably securing the cushion 1 to a support member, such as a pair of straps extending from the first cover 64 that are releasably coupled to each other (e.g., by tying together, using hook and loop fastener material, buttons, snaps, buckles, etc.), to fasten or attach the cushion 1a to the support member. In still further alternative constructions a second coupling means may extend from the second cover 68 such that the second cushion portion 52 may be independently attachable or fastened to the support member. Such a second coupling means may be similar or identical to those described above for the first coupling means.

When using the cushion 1a, the second cushion portion 52 is removed from the recess 24a and the lateral support portions 16a, 20a of the first foam body 56 are positioned around the neck of the user to provide support to the neck of the user, whereas a rear 76 of the first foam body 56 (FIG. 4) may directly support the rear of user's neck. The second cushion portion 52 can be positioned adjacent lumbar or posterior regions of the user to provide support to the lumbar or posterior regions of the user. Additionally, the second cushion portion 52 can be positioned in the recess 24a of the first cushion portion 48 to form a single cushion 1a. The single cushion 1a (i.e., the combination of or coupled first and second cushion portions 48, 52) can be positioned under the head and neck of the user to provide support to the head and neck of the user when in a reclined position (e.g., when lying in a bed). In other words, the cushion 1a can be operable during travel to provide comfort and support to the user in multiple configurations unlike a conventional cushion.

When the cushion 1a is not in use, the first and second cushion portions 48, 52 are coupled together and the cushion 1a is attachable to a support member (e.g., luggage, not shown) with the carabiner 40a for easy and convenient transport of the cushion 1a. As needed, the cushion 1a is washable by the user without necessitating removal of the first and second foam bodies 56, 60 from the first and second covers 64, 68 as compared to a conventional cushion, which requires removal of the foam body before the cover is washed.

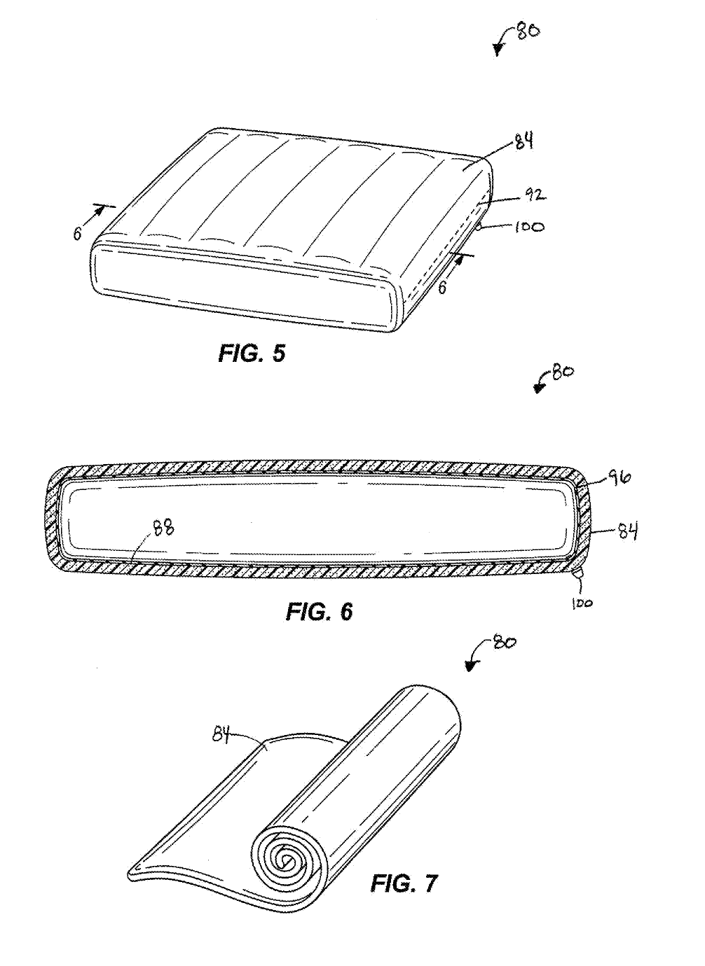

FIGS. 5-7 illustrate a third embodiment of a cushion 80 used during travel or transit by a user. The cushion 80 includes a foam sleeve 84 having viscoelastic foam. Alternatively, the foam sleeve 84 may include a non-viscoelastic foam (e.g., latex foam, HR polyurethane foam, etc). The properties (e.g., hardness, density, etc.) of the viscoelastic foam, latex foam, and HR polyurethane foam discussed above with respect to the first embodiment of the cushion 1 also apply to the cushion 80 of FIGS. 5-7, and will not be described again in detail. The foam sleeve 84 also has an interior 88 (FIG. 6) and an opening 92 (FIG. 5) for accessing the sleeve interior 88. The foam sleeve 84 further includes a closure (e.g, zipper; not shown) for opening and closing the opening 92. A bladder 96 is positioned in the sleeve interior 88 and is selectively removable from the foam sleeve 84 through the opening 92 in the sleeve 84. The bladder 96 is selectively deflatable to facilitate rolling the foam sleeve 84 into a cylindrical shape (FIG. 7). Particularly, the bladder 96 includes a valve or an inflation port 100 through which a liquid (e.g., water) or a gas (e.g., air) is introduced or released for inflating and deflating, respectively, the bladder 96. The bladder 96 is inflated or deflated to an extent necessary to provide the firmness and support required by the user.

When using the cushion 80, the liquidor gas is introduced into the bladder 96 via the inflation port 100 to inflate the bladder 96 until the cushion 80 provides the firmness and support desired by the user. For example, to inflate the cushion 80 with a liquid, the inflation port 100 can be coupled to a liquid source such as a faucet of a conventional sink to facilitate inflating the bladder 96. In another example, the inflation port 100 can be coupled to a gas source such as a pump, or the bladder 96 may be self-inflatable by the user. When the cushion 80 is not in use, the liquid or gas is removed or released from the bladder 96 to deflate the bladder 96. The cushion 80 then is rolled up for easy and convenient storage and transport of the cushion 80. By collapsing to a smaller size, the deflated and rolled cushion 80 fits into a smaller space (e.g., luggage), and thus requires less space as compared to a conventional cushion, thereby making it easier for the user to travel with and store the cushion.

Various features of the invention are set forth in the following claims.

What is claimed is:

1. A cushion comprising:
a foam body including first and second lateral support portions defining an elongated recess therebetween;
a cover at least partially enclosing the foam body; and
means for releasably coupling the cushion to a support member to facilitate transport of the support member and the cushion as a unit.

2. The cushion of claim 1, wherein the foam body includes viscoelastic foam.

3. The cushion of claim 2, wherein the viscoelastic foam includes a hardness of at least about 20 N and no greater than about 80 N.

4. The cushion of claim 2, wherein the viscoelastic foam includes a density of no less than about 30 kg/m³ and no greater than about 150 kg/m³.

5. The cushion of claim 1, wherein the foam body includes a latex foam.

6. The cushion of claim 5, wherein the latex foam includes a hardness of at least about 30 N and no greater than about 130 N.

7. The cushion of claim 5, wherein the latex foam includes a density of no less than about 40 kg/m³ and no greater than about 100 kg/m³.

8. The cushion of claim 1, wherein the foam body includes a high-resilience polyurethane foam.

9. The cushion of claim 8. wherein the high-resilience polyurethane foam includes a hardness of at least about 80 N and no greater than about 200 N.

10. The cushion of claim 8, wherein the high-resilience polyurethane foam includes a density of no less than about 10 kg/m³ and no greater than about 80 kg/m³.

11. The cushion of claim 1, wherein the foam body includes a first layer of viscoelastic foam and a second layer of non-viscoelastic foam adjacent the first layer.

12. The cushion of claim 11, wherein the second layer of non-viscoelastic foam is one of a latex foam and a high-resilience polyurethane foam.

13. The cushion of claim 1, wherein the foam body and the cover are washable as a unit.

14. The cushion of claim 1, wherein the coupling means includes a strap extending from the cover.

15. The cushion of claim 14, wherein the coupling means further includes a combiner attached to the strap.

16. The cushion of claim 1, wherein the foam body includes a tapered cross-sectional shape in a plane aligned with the recess.

17. The cushion of claim 1, wherein the foam body is a first foam body, and wherein the cushion further includes a second foam body positioned in the recess and removably coupled to the first foam body.

18. The cushion of claim 17, wherein the cover is a first cover at least partially enclosing the first foam body, and wherein the cushion further includes a second cover at least partially enclosing the second foam body.

19. The cushion of claim 18, further comprising means for securing the first and second covers.

20. The cushion of claim 17, wherein the first foam body is configured for supporting a head and neck of an individual, and wherein the second foam body is configured for supporting one of a lumbar region and a posterior region of the individual.

21. A cushion comprising:
a first foam body including first and second lateral support portions defining an elongated recess therebetween;
a first cover at least partially enclosing the first foam body;
a second foam body positioned in the recess and removably coupled to the first foam body; and
a second cover at least partially enclosing the second foam body.

22. The cushion of claim 21, further comprising means for securing the first and second covers.

23. The cushion of claim 21, wherein the first foam body is configured for supporting a head and neck of an individual, and wherein the second foam body is configured for supporting one of a lumbar region and a posterior region of the individual.

24. The cushion of claim 21, further comprising means for releasably coupling the cushion to a support member to facilitate transport of the support member and the cushion as a unit.

25. The cushion of claim 24, wherein the coupling means includes a strap extending from the first cover.

26. The cushion of claim 25, wherein the coupling means further includes a carabiner attached to the strap.

27. The cushion of claim 21, wherein the first and second foam bodies and the first and second covers are all washable as a unit.

28. The cushion of claim 21, wherein each of the first and second foam bodies includes viscoelastic foam.

29. The cushion of claim 21, wherein at least one of the first and second foam bodies includes a first layer of viscoelastic foam and a second layer of non-viscoelastic foam adjacent the first layer.

30. The cushion of claim 29, wherein the second layer of non-viscoelastic foam is one of a latex foam and a high-resilience polyurethane foam.

31. A cushion comprising:
a foam sleeve having an interior; and
a bladder positioned in the sleeve interior, the bladder being selectively deflated to facilitate rolling the foam sleeve into a cylindrical shape.

32. The cushion of claim 31, wherein the foam sleeve includes viscoelastic foam.

33. The cushion of claim 32, wherein the viscoelastic foam includes a hardness of at least about 20 N and no greater than about 80 N.

34. The cushion of claim 32, wherein the viscoelastic foam includes a density of no less than about 30 kg/m³ and no greater than about 150 kg/m³.

35. The cushion of claim 31, wherein the bladder includes an inflation port through which one of a liquid and a gas is introduced for inflating the bladder.

36. The cushion of claim 35, wherein the foam sleeve includes an opening for accessing the sleeve interior, and wherein the bladder is selectively removable from the sleeve through the opening.
